(19) United States
(12) Patent Application Publication
(10) Pub. No.: US 2014/0120327 A1
(43) Pub. Date: May 1, 2014

(54) LINERLESS MEDIA

(71) Applicant: Microcom Corporation, Lewis Center, OH (US)

(72) Inventor: David M. DEZSE, Lewis Center, OH (US)

(73) Assignee: Microcom Corporation, Lewis Center, OH (US)

(21) Appl. No.: 14/037,867

(22) Filed: Sep. 26, 2013

Related U.S. Application Data
(60) Provisional application No. 61/718,604, filed on Oct. 25, 2012.

(51) Int. Cl. G09F 3/10; G06K 19/06; B32B 38/00

(52) U.S. Cl. CPC G09F 3/10; B32B 38/0004; G06K 19/06028; G06K 19/06037
USPC 428/195.1; 156/60; 156/250; 156/510; 235/488

(57) ABSTRACT

A linerless media comprising selectively applied adhesive to allow cutting through a non-adhesive portion of the linerless media. The linerless media can be a linerless media web or linerless media labels with alternating adhesive portions and non-adhesive portion provided along a length of the linerless media web or linerless media label. The adhesive portion applied to the linerless media web or label can be an adhesive bar code.

### RELATED APPLICATIONS

This application is a Non-Provisional application claiming the benefit under 35 U.S.C. 119(e) of U.S. Provisional Application No. 61/718,604, filed on Oct. 25, 2012, the content of each of which is hereby incorporated by reference in its entirety.

### FIELD

A linerless media, in particular a linerless media web and a linerless media label, web device, label device, label making system, linerless media process, and method of making linerless media.

### BACKGROUND

A linerless media can be used to make labels. The labels cut from a continuous web of linerless material provided with an adhesive layer on a back side thereof.

The adhesive layer located on the back side of the web of linerless material can stick to components or parts of the cutting device, in particular a cutting edge of the cutting blade, when the continuous web is being cut (e.g. when a web of linerless material is being converted or cut into labels).

### SUMMARY OF THE INVENTION

A first object is to provide an improved linerless media or label.

A second object is to provide an improved linerless media or label comprising or consisting of adhesive on at least one side of the linerless media or label.

A third object is to provide an improved linerless media or label comprising or consisting of an adhesive layer on at least one side of the linerless media or label.

A fifth object is to provide an improved linerless media or label comprising or consisting of adhesive on a back side of the linerless media or label.

A sixth object is to provide an improved linerless media or label comprising or consisting of an adhesive layer on a back side of the linerless media or label.

A seventh object is to provide a linerless media or label comprising or consisting of adhesive selectively applied to at least one side of the linerless media or label.

An eighth object is to provide a linerless media or label comprising or consisting of an adhesive layer selectively applied to at least one side of the linerless media or label.

A ninth object is to provide a linerless media or label comprising or consisting of adhesive portions provided on at least one side of the linerless media or label.

A tenth object is to provide a linerless media or label comprising or consisting of adhesive layer portions provided on at least one side of the linerless media or label.

An eleventh object is to provide a linerless media or label comprising or consisting of adhesive layer zones provided on at least one side of the linerless media or label.

A twelfth object is to provide a linerless media or label comprising or consisting of adhesive portions on at least one side of the linerless media or label, the adhesive portions being spaced apart along a length, printing direction, and/or cutting direction of the linerless media or label.

A thirteenth object is to provide a linerless media or label comprising or consisting of an adhesive portion provided on at least one side of the linerless media or label, the adhesive portion not being applied at locations at which the linerless media or label is to be cut or perforated.

A fourteenth object is to provide a linerless media or label comprising or consisting of an adhesive portions provided on at least one side of the linerless media or label, the adhesive portion being spaced apart along at least one axes of the linerless media or label.

A fifteenth object is to provide a linerless media or label comprising or consisting of adhesive portions provided on at least one side of the linerless media, the adhesive portions being spaced apart transverse oriented adhesive portions positioned along at least one axis of the linerless media or label.

A sixteenth object is to provide a linerless media or label comprising or consisting of adhesive portions provided on at least one side of the linerless media or label, the adhesive portions being spaced apart transverse oriented adhesive bars positioned along at least one axes of the linerless media or label.

A seventeenth object is to provide a linerless media web comprising or consisting of adhesive portions provided on at least one side of the linerless media web, the adhesive portions being spaced apart adhesive portions position along at least one axis of the linerless media web.

A eighteenth object is to provide a linerless media web comprising or consisting of adhesive portions provided on at least one side of the linerless media web, the adhesive portions being spaced apart transverse oriented adhesive bars position along a length of the linerless media web.

A nineteenth object is to provide a linerless media or label comprising or consisting of adhesive portions provided on at least one side of the linerless media or label, the adhesive portions being spaced apart along a length, printing direction, and/or cutting direction of the linerless media or label; and registration markings provided on at least one side of the linerless media or label to locate the adhesive portions or non-adhesive portions on the linerless media or label.

A twentieth object is to provide a linerless media or label comprising or consisting of an adhesive portion provided on at least one side of the linerless media, the adhesive portion not being provided at locations at which the linerless media is to be cut or perforated; and registration markings on at least one side of the linerless media to locate the adhesive portions or non-adhesive portions on the linerless media or label.

A twenty first object is to provide a linerless media or label comprising or consisting of adhesive portions provided on at least one side of the linerless media or label, the adhesive portions being spaced apart along at least one axis of the linerless media or label; and registration markings provided on at least one side of the linerless media or label to locate the adhesive portions.

A twenty second object is to provide a linerless media or label comprising or consisting of adhesive portions provided on at least one side of the linerless media or label, the adhesive portions being spaced apart transverse oriented adhesive portions positioned along at least one axis of the linerless media or label; and registration markings provided on at least one side of the linerless media or label to locate the adhesive portions.

A twenty third object is to provide a linerless media or label comprising or consisting of adhesive portions provided on at least one side of the linerless media or label, the adhesive portions being spaced apart transverse oriented adhesive bars positioned along at least one axis of the linerless media; and registration markings provided on at least one side of the linerless media to locate the adhesive portions.

A twenty fourth object is to provide a linerless media web comprising or consisting of adhesive portions provided on at least one side of the linerless media web, the adhesive portions being spaced apart transverse oriented adhesive bars positioned along a length of the linerless media web; and registration markings on at least one side of the linerless media web to locate the adhesive portions or non-adhesive portions.

A twenty fifth object is to provide a method of making linerless media or label comprising cutting a linerless media web comprising an adhesive portion and non-adhesive portion provided on at least one side of the linerless media web.

A twenty sixth object is to provide a method of making a linerless label from a linerless web comprising an adhesive portion and non-adhesive portion, the method comprising cutting the linerless media web.

A twenty seventh object is to provide a method of making a linerless label from a linerless web comprising an adhesive portion and non-adhesive portion, the method comprising cutting the linerless media web at a location of the non-adhesive portion.

A twenty eighth object is to provide a method of making a linerless label from a linerless web comprising alternating adhesive portions and non-adhesive portions located on at least one side of the linerless web and along a length of the linerless web, the method comprising cutting the linerless web.

A twenty ninth object is to provide a method of making a linerless label from a linerless web comprising alternating adhesive portions and non-adhesive portions located on at least one side of the linerless web and along a length of the linerless web, the method comprising cutting the linerless web at a location of at least one of the non-adhesive portions.

A thirtieth object is to provide a method of making a linerless web with alternating adhesive portions and non-adhesive portions, the method comprising applying the adhesive portions spaced apart along a length of the linerless web.

A thirty first object is to provide a method of making a linerless web with alternating adhesive portions and non-adhesive portions, the method comprising printing the adhesive portions onto the linerless web.

A thirty second object is to provide a method of making a linerless web with alternating adhesive portions and non-adhesive portions, the method comprising printing the adhesive portions spaced apart along a length of the linerless web.

A thirty third object is to provide a linerless media or label comprising a first layer of material and a discontinuous second layer of adhesive applied to one side of the linerless media or label.

A thirty fourth object is to provide a linerless media or label comprising a first layer of material, a discontinuous second layer of adhesive applied to one side of the linerless media or label, and a third layer of adhesive applied to an opposite side of the linerless media.

A thirty fifth object is to provide a linerless media or label comprising a first layer of material, a discontinuous second layer of adhesive applied to one side of the linerless media or label, and a discontinuous third layer of adhesive applied to an opposite side of the linerless media.

A thirty sixth object is to provide a linerless media or label or web comprising a first layer of material, and a bar code adhesive layer provided on at least one side of the first layer of material.

A thirty seventh object is to provide a linerless media or label or web comprising a first layer of material, and a one-dimensional bar code adhesive layer provided on at least one side of the first layer of material.

A thirty eighth object is to provide a linerless media or label or web comprising a first layer of material, and a two-dimensional bar code adhesive layer provided on at least one side of the first layer of material.

A thirty ninth object is to provide a linerless media or label or web comprising a first layer of material, and a two-dimensional matrix bar code adhesive layer provided on both sides of the first layer of material.

A fortieth object is to provide a linerless media or label system comprising a linerless web comprising alternating adhesive and non-adhesive portions provided on at least one side of the linerless web.

A forty first object is to provide a linerless media or label system comprising a linerless web comprising alternating adhesive and non-adhesive portions provided on at least one side of the linerless web and a cutter for cutting the linerless web.

A forty second object is to provide a linerless media or label system comprising a linerless web comprising alternating adhesive and non-adhesive portions provided on at least one side of the linerless web and a cutter for cutting the linerless web at locations of the non-adhesive portions.

A forty third object is to provide a linerless media or label system comprising a linerless web comprising alternating adhesive and non-adhesive portions provided on at least one side of the linerless web and a cutter for cutting the linerless web at locations of the non-adhesive portions to make linerless labels.

The linerless media can be a single layer, or multiple layers. The linerless media can be a sheet, web, or other format. Further, the linerless media can be a single layer, multiple layer, composite layers of paper, cloth, fabric, cardboard, plastic, film, or other suitable material. The linerless label can be a single layer, or multiple layers. The linerless label can be any size, shape, or design.

For example, a web of linerless media is applied (e.g. selectively applied) with a layer of adhesive on at least one side (e.g. back side) of the web. Alternatively, a layer of adhesive in a particular pattern, design, art design, matrix, picture, dots, shading, or other shaped is applied to one or both sides of the linerless media.

The web of linerless media can be applied (e.g. printed) with alternating adhesive and non-adhesive bar portions with the adhesive bar portions separated by non-adhesive bar portions (e.g. like a one-dimensional bar code having same width adhesive bar-shaped portions separated by same width bar-shaped non-adhesive portions). For example, the bars can be oriented transverse relative to a length of the web (i.e. direction of movement of web for printing, cutting, applying adhesive, or printing adhesive).

The linerless web is converted into linerless media labels by cutting the web at the location of the non-adhesive bar portions so that the cutting edge of the cutting blade does not cut through any adhesive or adhesive layer. Alternatively, the adhesive or adhesive layer on the linerless web is arranged and located so that the cutting blade edge cuts through a reduced amount of adhesive or adhesive layer by providing adhesive portions and non-adhesive portions on at least one side of the linerless web, and minimizing the adhesive portions at locations where the cutting edge of the cutting blade cuts through the linerless web.

The linerless web is provided with registration markings (e.g. marks, black marks, bars, dots adhesive, adhesive registration marks) used to locate the non-adhesive bar portions on the linerless web to allow the linerless web to be cut through at locations of the non-adhesive bar portions. The cutter is configured to mechanically and/or electrically register and control the cutter blade timing of the cutter so that the cutter cuts through the linerless web at the location of the non-adhesive portions of the linerless web. In this manner, the cutting edge of the cutting blade of the cutter does not cut through any adhesive or adhesive layer on the linerless web when cutting the linerless web (e.g. cutting linerless web into labels), which adhesive or adhesive layer gums up and/or dulls the cutting edge.

The registration marks can be located on the same side of the web as the adhesive or adhesive layer, located on the opposite side, or located on both sides. Further, the registration marks can be applied (e.g. printed) on the adhesive portions, applied on the non-adhesive portions, or applied both the adhesive portions and non-adhesive portions.

As an alternative, a reduced or minimized amount of adhesive or adhesive layer is provided at the cutting or perforating locations on the linerless web. For example, the thickness layer of the adhesive is reduced or minimized at the location of cutting of the linerless web, or the adhesive or adhesive layer is located on the linerless web (e.g. adhesive pattern, portions, zones) so that only a reduced or minimized amount of adhesive is cut (e.g. organized pattern of adhesive or adhesive layer, random pattern of adhesive or adhesive layer, adhesive image, adhesive picture, adhesive shading, fixed adhesive pattern or footprint, variable adhesive pattern or foot print). Reducing or eliminating the adhesive or adhesive layer coming into contact with the cutting edge of the cutter blade edge of the cutter is important. A matrix of adhesive portions (e.g. dots, triangles, squares, stars, circles) can allow for cutting the web both longitudinally and lengthwise while avoiding adhesive completely or substantially.

For example, the adhesive or adhesive layer can be made of a releasable type adhesive material (e.g. adhesive on 3M Sticky Notes), or can be more aggressive (i.e. semi non-releasable to permanent type adhesive). The selectively applied adhesive allows for the linerless material to still work in a printer (i.e. does not stick to printer components or parts, does not jam printer) while resulting in a label that substantially permanently sticks to an article, object, document, form, etc. (i.e. does not inadvertently unstick after being applied to a surface, article, package, paper, cardboard, plastic, metal, glass, wood, laminate). This type of label can be particularly useful in postal and courier type applications on labels for mail, packages, articles, objects, and other items to be shipped, and in particular applications where the label's retention after being applied to a surface is challenged.

### DRAWINGS

FIG. 1 is a planar view of a front side of a first example of a linerless media.

FIG. 2 is a planar view of a rear side of the linerless media shown in FIG. 1.

FIG. 3 is a planar view of a front side of a second example of a linerless media label web.

FIG. 4 is a planar view of a rear side of the linerless media web shown in FIG. 3.

FIG. 5 is a planar view of a front side of a third example of a linerless media web.

FIG. 6 is a planar view of a rear side of the linerless media web shown in FIG. 5.

FIG. 7 is a planar view of a front side of a fourth example of a linerless media web.

FIG. 8 is a planar view of a rear side of the linerless media web shown in FIG. 7.

FIG. 9 is a planar view of a front side of a first example of a linerless media label.

FIG. 10 is a planar view of a rear side of the linerless media label shown in FIG. 9.

FIG. 11 is a planar view of a front side of a second example of a linerless media label.

FIG. 12 is a planar view of a rear side of the linerless media label shown in FIG. 11.

FIG. 13 is a planar view of a front side of a third example of a linerless media label.

FIG. 14 is a planar view of a rear side of the linerless media label shown in FIG. 13.

FIG. 15 is a planar view of a front side of a fourth example of a linerless media label.

FIG. 16 is a planar view of a rear side of the linerless media label shown in FIG. 15.

FIG. 17 is a planar view of a front side of a first layer of a first example of a liner media.

FIG. 18 is a planar view of a rear side of the first layer of the liner media shown in FIG. 17.

FIG. 19 is a planar view of a front side of a second layer (i.e. release layer or liner) of the first example of a liner media web.

FIG. 20 is a planar view of a rear side of the second layer shown in FIG. 19.

FIG. 21 is a photograph perspective view of the liner type media web shown in FIGS. 17-20.

FIG. 22 is a planar view of a front side of a fifth example of a linerless media label comprising a bar code printed on a front side of the linerless media label.

FIG. 23 is a planar view of a rear side of the linerless media label shown in FIG. 22.

FIG. 24 is a planar view of a front side of a sixth example of a linerless media label.

FIG. 25 is a planar view of a rear side of the linerless media label shown in FIG. 24.

### DESCRIPTION

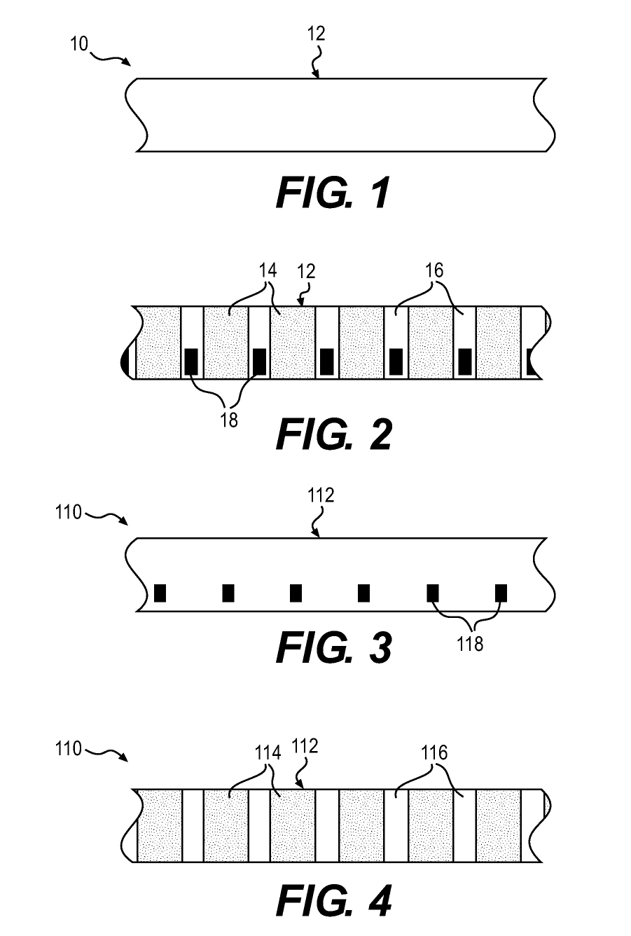

A first example of a linerless media 10 is shown in FIGS. 1 and 2. A front side (FIG. 1) of the linerless web 12 is shown blank; however, the front side can be printed on before or after making the linerless web 12.

A rear side (FIG. 2) of the linerless web 12 comprises alternating adhesive bar-shaped portions 14 (i.e. portions where adhesive is applied onto linerless web 12) separated or spaced apart by non-adhesive bar-shaped portions 16 (i.e. portions where no adhesive is applied to linerless web 12).

The adhesive bar-shaped portions 14 and non-adhesive bar-shaped portions 16 are oriented transverse relative to a longitudinal direction of the web 12 (i.e. the web advancing direction when being printed, cut, perforated, or otherwise processed).

The adhesive bar-shaped portions 14 are selectively applied by an applicator (e.g. adhesive applicator, adhesive printer). For example, the applicator comprises an application wheel with spaced apart alternating raised and lowered wheel surface portions selectively applying the spaced apart adhesive bar-shaped portions 14 onto the linerless web 12. Alternatively, an adhesive applicator fixed relative to the movement of the linerless web 12 is configured and/or selectively operated (e.g. mechanically and/or electronically timed) to apply the spaced apart adhesive bar-shaped portions 14 to the linerless web 12.

The adhesive portions 14 and non-adhesive portions 16 can be configured as a zone, area, pattern, repeating pattern, non-repeating pattern, random pattern, non-random pattern, image, matrix, picture, bar code, shaded pattern, or other suitable design. Further, the adhesive portions 14 can be of uniform thickness, non-uniform thickness, varying thickness, continuous, and/or discontinuous.

The rear side of the linerless web 12 is provided (e.g. printed) with spaced apart registration marks 18 (e.g. bar-shaped registration marks shown, sensing marks, bar code, lines, dots, matrix, other registration marks or sensing marks). The registration marks 18 are shown centered relative to the non-adhesive bar-shaped portions 16. However, the registration marks can be located centered relative to the non-adhesive bar portions 14. Alternatively, the registration marks 18 can be located relative to the leading edge or trailing edge of the non-adhesive portions 14 and/or adhesive portions 16.

A second example of a linerless media 110 is shown in FIGS. 3 and 4. A front side (FIG. 3) of the linerless web 112 is provided with the registration marks 118. The remaining blank portion of the front side can be printed on before or after making the linerless web 112.

A rear side (FIG. 4) of the linerless web 112 comprises alternating adhesive bar-shaped portions 114 (i.e. portions where adhesive is applied onto linerless web 112) separated or spaced apart by non-adhesive bar-shaped portions 116 (i.e. portions where no adhesive is applied to linerless web 112).

The adhesive bar-shaped portions 114 and non-adhesive bar-shaped portions 116 are oriented transverse relative to a longitudinal direction of the web 112 (i.e. the web advancing direction when being printed, cut, perforated, or otherwise processed).

The adhesive bar-shaped portions 114 are selectively applied by an applicator (e.g. adhesive applicator, adhesive printer). For example, the applicator comprises an application wheel with spaced apart alternating raised and lowered wheel surface portions selectively applying the spaced apart adhesive bar-shaped portions 114 onto the linerless web 112. Alternatively, an adhesive applicator fixed relative to the movement of the linerless web 112 is configured and/or selectively operated (e.g. mechanically and/or electronically timed) to apply the spaced apart adhesive bar-shaped portions 114 to the linerless web 112.

The adhesive portions 114 and non-adhesive portions 116 can be configured as a zone, area, pattern, repeating pattern, non-repeating pattern, random pattern, non-random pattern, image, matrix, picture, bar code, shaded pattern, or other suitable design. Further, the adhesive portions 114 can be of uniform thickness, non-uniform thickness, varying thickness, continuous, and/or discontinuous.

The rear side of the linerless web 112 is provided (e.g. printed) with spaced apart registration marks 118 (e.g. bar-shaped registration marks shown, sensing marks, bar code, lines, dots, matrix, other registration marks or sensing marks). The registration marks 118 are shown centered relative to the non-adhesive bar-shaped portions 116. However, the registration marks can be located anywhere, for example, centered relative to the non-adhesive bar portions 114. Alternatively, the registration marks 118 can be located relative to the leading edge or trailing edge of the non-adhesive portions 114 and/or adhesive portions 118.

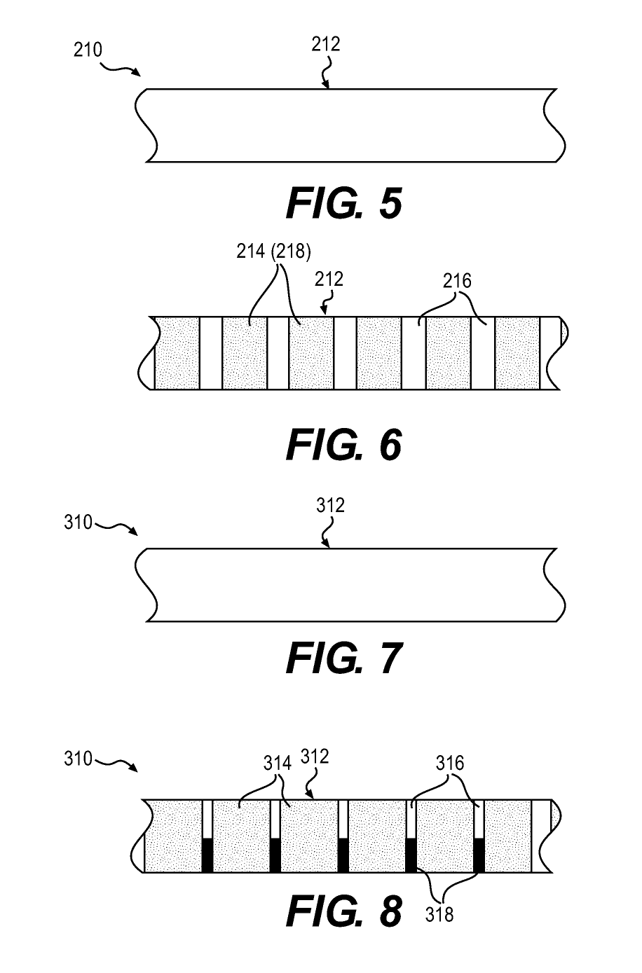

A third example of a linerless media 210 is shown in FIGS. 5 and 6. A front side (FIG. 5) of the linerless web 212 is blank and can be printed on before or after making the linerless web 212.

A rear side (FIG. 5) of the linerless web 212 comprises alternating adhesive bar-shaped portions 214 (i.e. portions where adhesive is applied onto the linerless web 212) separated or spaced apart by non-adhesive bar-shaped portions 216 (i.e. portions where no adhesive is applied to linerless web 212).

The adhesive bar-shaped portions 214 and non-adhesive bar-shaped portions 216 are oriented transverse relative to a longitudinal direction of the web 212 (i.e. the web advancing direction when being printed, cut, perforated, or otherwise processed).

The adhesive bar-shaped portions 214 are selectively applied by an applicator (e.g. adhesive applicator, coater, sprayer, printer, transfer roller or web). For example, the applicator comprises an application wheel with spaced apart alternating raised and lowered wheel surface portions selectively applying the spaced apart adhesive bar-shaped portions 214 onto the linerless web 212. Alternatively, an adhesive applicator fixed relative to the movement of the linerless web 212 is configured and/or selectively operated (e.g. mechanically and/or electronically timed) to apply the spaced apart adhesive bar-shaped portions 214 to the linerless web 212.

In this example, the adhesive portions 214 can be configured as zones, area(s), pattern(s), repeating pattern(s), non-repeating pattern(s), random pattern(s), non-random pattern(s), image(s), matrix, picture, bar code, shaded pattern, or other suitable design. Further, the adhesive portions 214 can be of uniform thickness, non-uniform thickness, varying thickness, continuous, and/or discontinuous.

In this example, the adhesive portions 214 also serve as the registration marks 218 (e.g. colored registration marks, black, dye, overprinted, overprinted to darken). The rear side of the linerless web 212 is provided (e.g. applied, printed, coated, sprayed) with spaced apart registration marks 218 (e.g. bar-shaped registration marks, sensing marks, bar code, lines, dots, matrix, other registration marks or sensing marks).

A fourth example of a linerless media 310 comprising a linerless web 312 is shown in FIGS. 7 and 8. A front side (FIG. 7) of the linerless web 312 is blank and can be printed on before or after making the linerless web 312.

A rear side (FIG. 8) of the linerless media 310 is shown in FIG. 8. The rear side of the linerless media web 310 comprises alternating adhesive bar-shaped portions 314 (i.e. adhesive applied on linerless web 312) separated by or spaced apart by non-adhesive bar-shaped portions 316 (i.e. no adhesive applied to linerless web 12).

The adhesive bar-shaped portions 314 and non-adhesive bar-shaped portions 316 are oriented transverse relative to a longitudinal direction of the web 312 (i.e. the web advancing direction when being printed, cut, perforated, or otherwise processed).

The adhesive bar-shaped portions 314 are selectively applied by an applicator (e.g. adhesive applicator, adhesive printer). For example, the applicator comprises an application wheel with spaced apart alternating raised and lowered wheel surface portions selectively applying spaced apart bar-shaped adhesive portions or zones onto the linerless web 312. Alternatively, a fixed adhesive applicator is configured and/or selectively operated (e.g. mechanically and/or electronically timed) to apply the spaced apart adhesive bar-shaped portions 314 to the linerless web 312.

The adhesive portions 314 and/or non-adhesive portions 316 can be a pattern, repeating pattern, non-repeating pattern, random pattern, non-random pattern, image, matrix, picture, bar code, shaded pattern, or other suitable design. Further, the adhesive portions 314 can be of uniform thickness, non-uniform thickness, varying thickness, continuous, and/or discontinuous.

The rear side (FIG. 8) is provided (e.g. printed) with spaced apart registration marks 318 (e.g. bar-shaped registration marks shown, bar code, lines, dots, matrix, other registration type markings). The registration marks 318 are shown centered relative to the non-adhesive bar-shaped portions 316. In addition, it is noted that the width of the registration marks 318 are the same as the width of the non-adhesive portions 316.

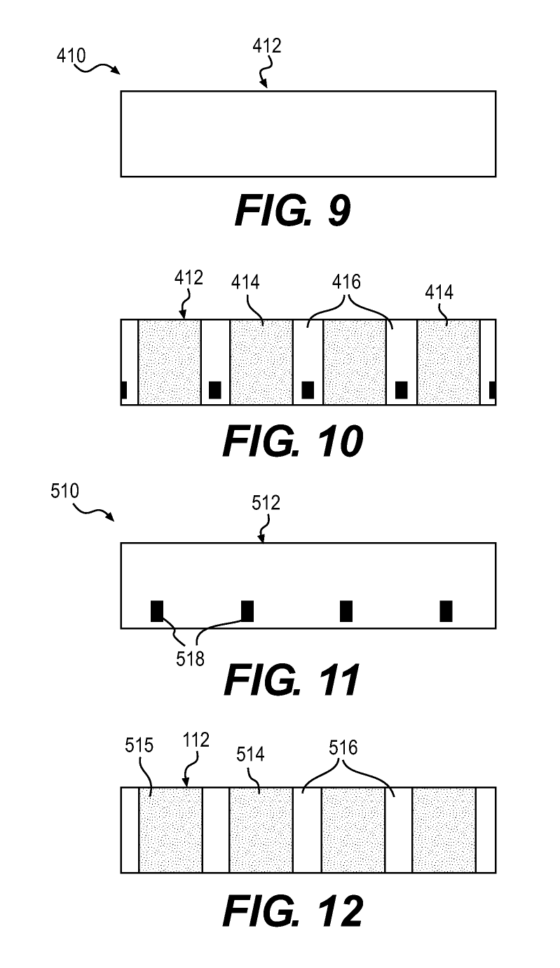

A first example of a linerless media label 410 is shown in FIGS. 9 and 10. The linerless media web label 410, for example, can be cut or converted from the linerless media 10 shown in FIGS. 1 and 2.

A front side (FIG. 9) of the linerless media label 410 is blank. A rear side (FIG. 10) of the linerless media label 410 is provided with alternating adhesive portions 414 and non-adhesive portions 416, and registration marks 418.

It is noted that the leading and trailing edges of the label 410 are shown cut in the non-adhesive portions 414 so that the cutting edge of the cutting blade of the cutter does not cut through any adhesive or adhesive layer. This prevents build up (i.e. gumming up) of adhesive on the cutting edge of the cutting blade, and prevents dulling of the cutting edge.

A second example of a linerless media label 510 is shown in FIGS. 11 and 12. The linerless media web label 510, for example, can be cut or converted from the linerless media 110 shown in FIGS. 3 and 4.

A front side (FIG. 11) of the linerless media label 510 is blank. A rear side (FIG. 12) of the linerless media label 510 is provided with alternating adhesive portions 514 and non-adhesive portions 516, and registration marks 518.

It is noted that the leading and trailing edges of the label 510 are shown cut in the non-adhesive portions 414 so that the cutting edge of the cutting blade of the cutter does not cut through any adhesive or adhesive layer. This prevents build up (i.e. gumming up) of adhesive on the cutting edge of the cutting blade, and prevents dulling of the cutting edge.

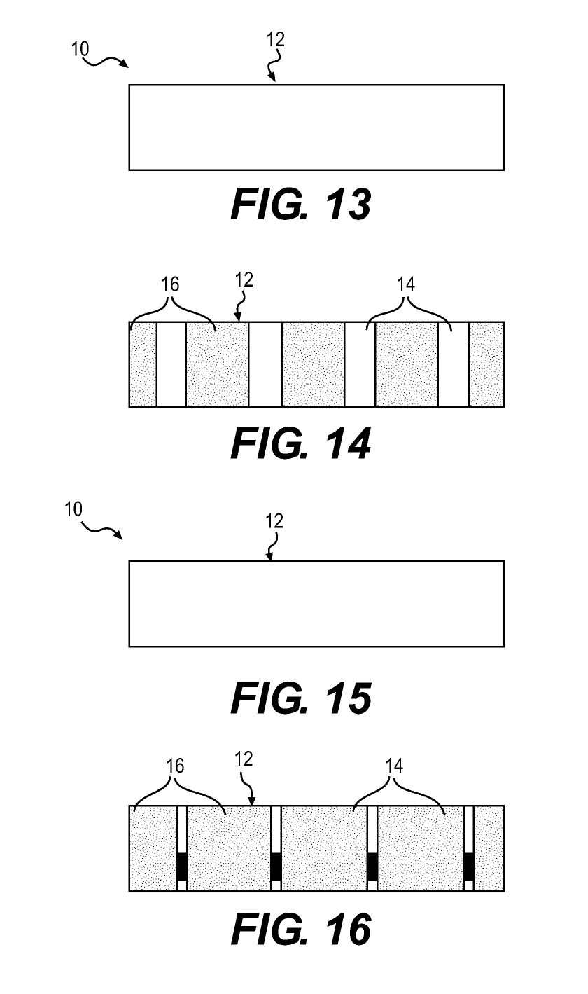

A first example of a liner type media 610 shown in FIGS. 13-17. The liner type media 610 comprises a liner type media web 610 that can be cut into labels. The liner type media web 612 comprises a first web layer 612 (FIGS. 13 and 14) and a second web layer 620 (e.g. release layer or liner) (FIGS. 15 and 16).

The front side of the first layer 612, for example, is blank and can be printed on with a printer. The rear side of the front layer 612 is provided with alternating adhesive portions 614 and non-adhesive portions 616 (i.e. the adhesive portions 614 are spaced apart by the non-adhesive portions 616).

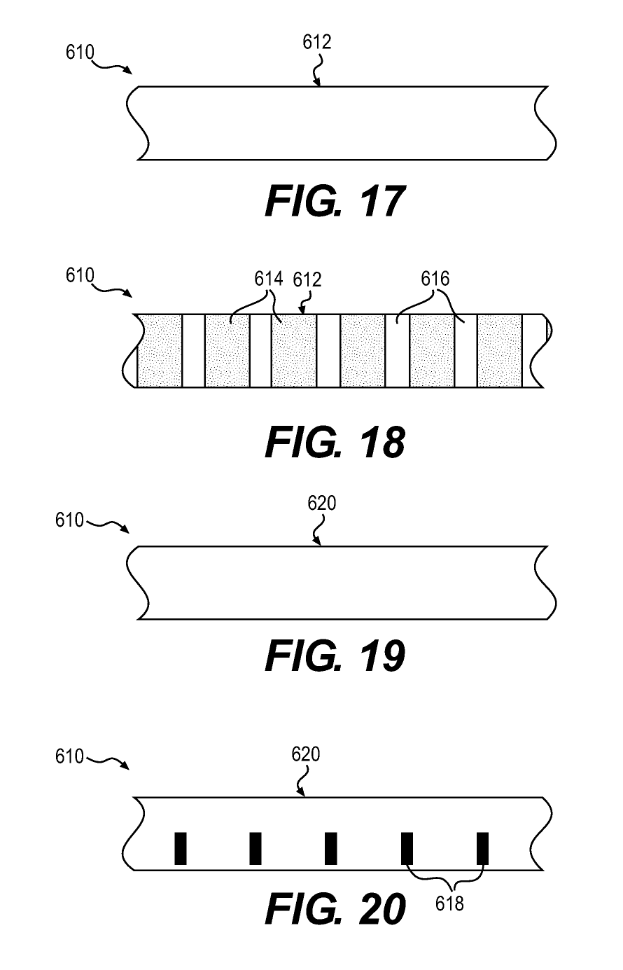

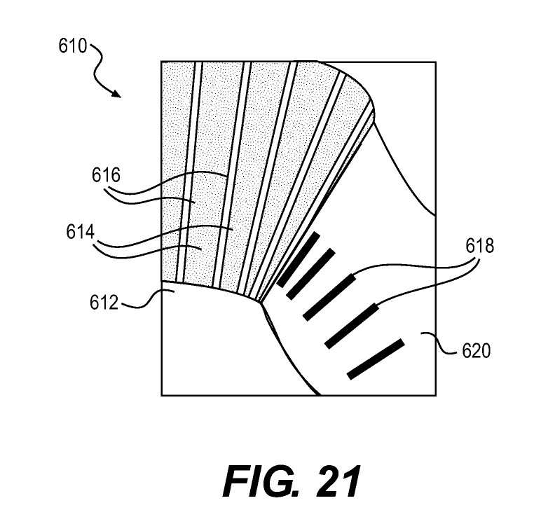

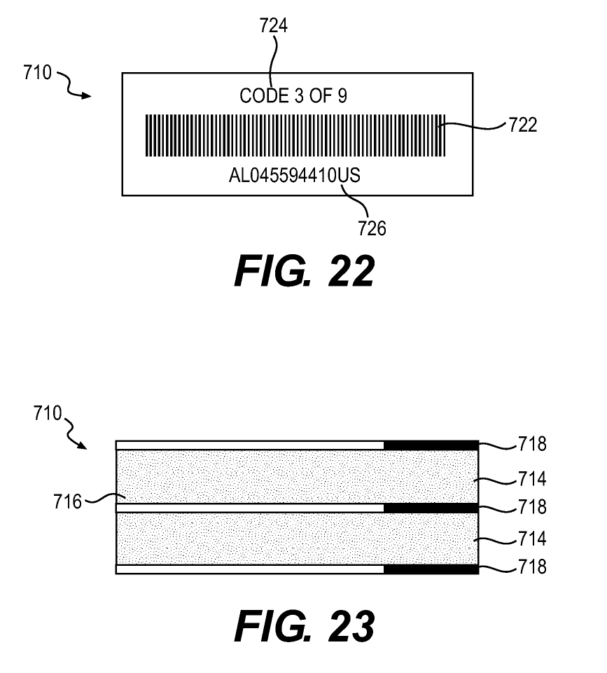

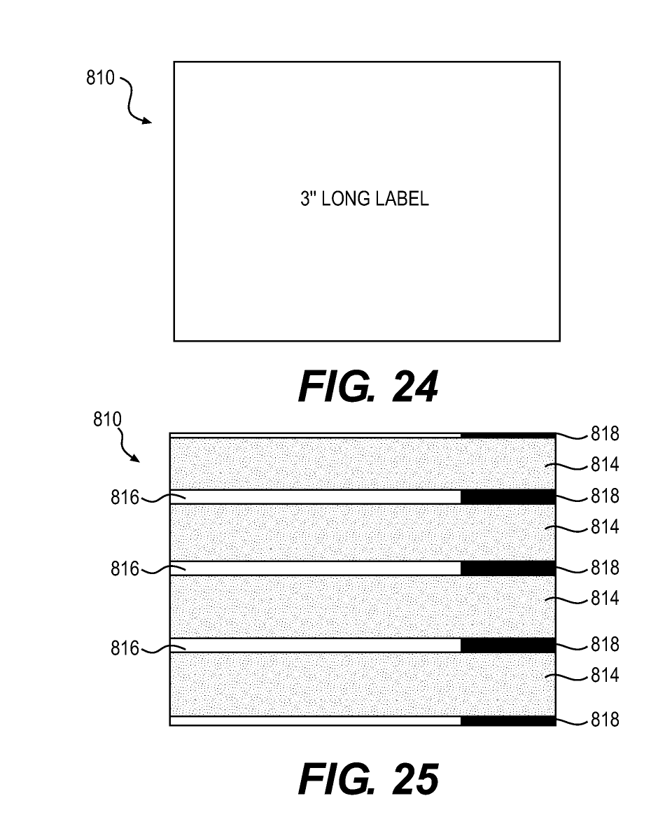

The front side of the second layer 620 is blank, and a rear side of the second layer 620 is printed with registration marks 618 (e.g. sensing marks). The registration marks 618 are located on the second layer 620. As shown in FIG. 17, the registration marks can be seen through the semi-transparent second layer 620.

When the second layer 620 is separated from the front layer 612, on the rear side of the first layer 612 there exists exposed alternating adhesive bar-shaped portions 214 and non-adhesive bar-shaped portions 216. The separated first layer 612 becomes a linerless media web 612, which can be further processed, converted, or cut into labels. Thus, liner media 610 can be used to make linerless media web 612 when separated from the second layer 620, or linerless labels. Alternatively, the liner media 610 can be processed, converted, or cut into labels having a second layer (e.g. release layer or liner), but having aggressive adhesive (e.g. permanent adhesive).

A third example of a linerless media label 710 is shown in FIGS. 17 and 18. The linerless media web label 710, for example, can be cut or converted from the linerless media 310 shown in FIGS. 7 and 8.

A front side (FIG. 17) of the linerless media label 710 is printed with a bar code 722, a code numbering 724, and a code listing 726. A rear side (FIG. 18) of the linerless media label 710 is provided with alternating adhesive portions 714 and non-adhesive portions 716, and registration marks 718.

It is noted that the leading (upper) and trailing (lower) edges of the label 710 are shown cut in the non-adhesive portions 714 so that the cutting edge of the cutting blade of the cutter does not cut through any adhesive or adhesive layer. This prevents build up (i.e. gumming up) of adhesive on the cutting edge of the cutting blade, and prevents dulling of the cutting edge.

A fourth example of a linerless media label 810 is shown in FIGS. 19 and 20. The linerless media web label 810, for example, can be cut or converted from the linerless media 310 shown in FIGS. 7 and 8.

A front side (FIG. 19) of the linerless media label 710 is blank (i.e. the size of the label being a 3″ Long Label is shown for illustrative purposed). A rear side (FIG. 20) of the linerless media label 810 is provided with alternating adhesive portions 814 and non-adhesive portions 816, and registration marks 818.

It is noted that the leading (upper) and trailing (lower) edges of the label 810 are shown cut in the non-adhesive portions 814 so that the cutting edge of the cutting blade of the cutter does not cut through any adhesive or adhesive layer. This prevents build up (i.e. gumming up) of adhesive on the cutting edge of the cutting blade, and prevents dulling of the cutting edge.

I claim:

1. A linerless media, comprising:
at least one layer comprising selectively applied adhesive portions spaced apart along a length of the first layer.

2. The linerless media according to claim 1, wherein the at least one layer comprises registration markings for locating the location of the adhesive portions applied to the at least one layer.

3. The linerless media according to claim 1, wherein the at least one layer is a web.

4. The linerless media according to claim 1, wherein the at least one layer is a label.

5. The linerless media according to claim 1, wherein the adhesive portions are adhesive bar-shaped portions spaced apart by non-adhesive bar-shaped portions along a length of the at least one layer.

6. The linerless media according to claim 5, wherein the bar-shaped adhesive portions are oriented transverse relative to a length of the at least one layer.

7. The linerless media according to claim 1, wherein the selectively applied adhesive portions is an adhesive bar code.

8. The linerless media according to claim 7, wherein the adhesive bar code is a one dimensional bar code.

9. The linerless media according to claim 8, wherein the adhesive bar code comprises alternating adhesive bar-shaped portions and non-adhesive bar-shaped portions.

10. The linerless media according to claim 9, wherein the adhesive bar-shaped portions have a fixed width.

11. The linerless media according to claim 9, wherein the non-adhesive bar-shaped portions have a fixed width.

12. The linerless media according to claim 10, wherein the non-adhesive bar-shaped portions have a fixed width.

13. The linerless media according to claim 7, wherein the adhesive bar code is a two-dimensional bar code.

14. The linerless media according to claim 13, wherein the adhesive bar code is matrix bar code.

15. A linerless media, comprising:
at least one layer comprising an adhesive bar code provided on at least one side of the at least one layer.

16. The linerless media according to claim 15, wherein the adhesive bar code is a two-dimensional bar code.

17. The linerless media according to claim 15, wherein the adhesive bar code is a two-dimensional bar code.

18. The linerless media according to claim 17, wherein the adhesive bar code is matrix bar code.

19. A method of making a linerless media, comprising:
providing at least one media layer; and
selectively applying spaced apart adhesive portions onto the at least one layer in a processing direction of the at least one layer.

20. The method according to claim 19, wherein the adhesive portions are adhesive bar-shaped portions spaced apart by non-adhesive bar-shaped portions.

21. The method according to claim 19, wherein the spaced apart adhesive portions are an adhesive bar code.

22. A method of making linerless labels, comprising:
providing a linerless media web;
selectively applying spaced apart adhesive portions to the linerless media web, the adhesive portions being spaced apart by non-adhesive portions; and
cutting the web at locations of the non-adhesive portions to make the labels.

23. The method according to claim 22, wherein the spaced apart adhesive portions are an adhesive bar code.

24. A system of making linerless media, comprising:
an applicator for selectively applying spaced apart adhesive portions to at least one side of a media web; and
a cutter configured to cut between the adhesive portions to convert the media web.
